(19) United States
(12) Patent Application Publication
(10) Pub. No.: US 2026/0146718 A1
(43) Pub. Date: May 28, 2026

(54) METHOD FOR IDENTIFYING PIPELINE FAILURES

(71) Applicant: Petróleo Brasileiro S.A. - Petrobras, Rio de Janeiro (BR)

(72) Inventors: Fabio Cesar DIEHL, Rio de Janeiro (BR); Leonardo DOS SANTOS PEREIRA, Rio de Janeiro (BR); Thiago Koichi ANZAI, Rio de Janeiro (BR)

(73) Assignee: Petróleo Brasileiro S.A. - Petrobras, Rio de Janeiro (BR)

(21) Appl. No.: 19/397,585

(22) Filed: Nov. 21, 2025

(30) Foreign Application Priority Data
Nov. 28, 2024 (BR) 1020240248309

(51) Int. Cl. F17D 5/06; F17D 3/01

(52) U.S. Cl. CPC F17D 5/06; F17D 3/01

(57) ABSTRACT

The present invention relates to a method for identifying pipeline failures that enables the detection of specific failures in critical events, since it presents an optimized search space for obtaining a precise and adaptable trained model, based on the use of a hybrid database comprising operational data and simulated data, and feedback from performance metrics combining variable data in an optimizer, generating machine learning models with greater specialization capacity and consequently allowing an increased capacity for classifying critical events.

### CROSS-REFERENCE TO RELATED APPLICATIONS

This application claims priority to Brazilian Patent Application No. 10 2024 024830 9, filed Nov. 28, 2024, the entire contents of which is incorporated herein by reference.

### FIELD OF THE DISCLOSURE

The present invention relates to the technical field of offshore oil exploration and production and the technology for monitoring the integrity of gas injection wells in oil reservoirs. More specifically, it relates to a method for identifying pipeline failures.

### BACKGROUND OF THE DISCLOSURE

The gas injection systems in pre-salt reservoirs use compressors that increase gas pressure from 150 bar (2175.57 psi) (15 MPa) to approximately 400 bar (5801.51 psi) (40 MPa), operating in composition ranges that can vary between 15% and 80% CO₂. However, the combination of high CO₂ contents, the presence of water, and the stress cycles in flexible reinjection pipelines can result in corrosion and crack formation. These structural degradation phenomena can lead to catastrophic failures due to fractures in a short period of time, significantly compromising the service life of the pipelines.

This type of corrosion, known as “Stress Corrosion Cracking” (SCC), is a corrosion embrittlement process induced by mechanical and corrosive stresses. When it occurs in flexible CO₂ injection lines, it can cause the piping to suddenly rupture, releasing gases into the marine environment. Depending on the conditions of the rupture, these gases can either dissolve in seawater or rise to the ocean surface, resulting in severe environmental impacts and jeopardizing the safety of the production operations. Therefore, it is crucial that such events be detected quickly to allow immediate shutdown of the compression plant, halting the gas injection into the sea.

However, the immediate detection of ruptures in gas injection lines is not a simple task, and, therefore, effective rupture monitoring systems currently do not exist. The traditional methods, which use isolated variables, such as the depressurization rate, which has limitations, often also have poor performance, which can result in a high number of false positives or false negatives. A false positive occurs when an alarm is triggered without a true failure, while a false negative occurs when a true failure is not detected. These errors can lead to improper interlocks or a failure to stop gas injection, compromising operational safety. In addition, methods that generate many false alarms tend to lose credibility with operating teams and are often deactivated.

Some methods for detecting ruptures and leaks in gas injection lines currently used in the industry are:
1) Mass Balance: This method compares the amount of gas injected with the amount that should be present in the line. A discrepancy may indicate a leak. It is a simple technique, but it can be limited in detecting small leaks.
2) Statistical Models: These use algorithms to analyze normal operating patterns and detect anomalies. Time series analysis techniques are used to identify deviations from expected behavior.
3) Negative Pressure Waves: these detect leaks by observing pressure waves that propagate through the line when a rupture occurs. This method can be sensitive to rapid variations, but may not be as effective in systems with high complexity and noise.
4) Real-Time Transient Model (RTTM): One of the most precise techniques, it uses detailed mathematical models to represent the dynamic behavior of the fluid in the line. It can identify even small leaks, but requires a high level of instrumentation and real-time processing.
5) Pressure and Temperature Analysis: changes in these variables along the line to identify potential anomalies are monitored. It can be most effective when combined with other methods, such as mass balance or RTTM, to increase the reliability.

These methods vary in complexity, cost, and effectiveness, and are often combined to provide a robust monitoring system.

Reducing false positives in monitoring and control systems is essential to optimizing the operation of the reinjection compressors on oil and gas production platforms. False positives can lead to unscheduled equipment shutdowns, resulting in significant operational and financial impacts. Each unscheduled shutdown of a reinjection compressor has a series of adverse consequences. First, compressor shutdowns reduce the FPSO's (Floating Production Storage and Offloading) processing capacity, directly affecting the efficiency of the production operations. The compressor plays a crucial role in gas reinjection, helping to maintain the reservoir pressure and optimize the oil recovery. When the compressor is forced to shut down, the gas reinjection capacity is limited, which can lead to a decrease in production and, consequently, a loss of revenue. Furthermore, the unscheduled shutdowns also result in direct oil and gas losses. During a shutdown, the flow of oil and gas that would normally be processed and reinjected is interrupted, leading to significant economic losses. This financial impact is magnified when considering that each shutdown can require maintenance and inspection procedures, which are often time-consuming and costly.

Additionally, the rapid identification of a catastrophic failure event is a crucial factor in ensuring the safety of the offshore production facilities. In oil and gas production environments, a failure in gas injection systems can have severe consequences, not only for the integrity of the facilities, but also for the safety of workers and the environment. An immediate and effective response to these events is essential to mitigate risks and prevent major incidents, such as gas leaks that can reach the sea surface and result in fires or explosions. The natural gas injection, especially when performed in large volumes and at high pressures, presents an inherent risk. In the event of a rupture or structural failure in injection lines, the gas can escape uncontrolled into the marine environment. If this gas reaches the sea surface, it can disperse into the atmosphere and, in the presence of an ignition source, a fire or explosion can occur, endangering the lives of workers, facilities, and nearby support vessels. In addition, such an event can trigger a cascading sequence of failures, further compromising the operational safety and the integrity of the facilities.

Complementarily, the rapid detection of a rupture in gas injection lines is crucial to reducing the environmental impacts associated with the offshore operations. When a rupture occurs, the ability to immediately halt gas injection into the sea is essential to mitigate the negative effects on the marine ecosystem. Natural gas, especially when rich in CO₂, can cause significant changes in seawater chemistry. One of the main consequences of this leak is a reduction in the water's pH, a phenomenon known as acidification, which can have devastating effects on marine life. The seawater acidification directly affects organisms such as corals, mollusks, and crustaceans, which depend on a balanced pH environment to form their calcareous structures. In addition, changes in pH can impact vital processes for a wide variety of marine species, from plankton—the base of the ocean food chain—to fish and marine mammals. Therefore, the presence of monitoring and early detection systems for ruptures not only protects the integrity of operations but also plays a crucial role in preserving biodiversity and ocean ecosystems.

Furthermore, the benefits of this detection extend beyond the operational efficiency and environmental safety, directly impacting the quality of life of the communities and the social responsibility of the companies. Since gas leaks can have adverse effects on the health of the local communities, for example, natural gas leaks, especially when containing CO₂, can lead to health problems for nearby residents, such as respiratory and cardiovascular irritation.

Given this scenario, there is a need to develop a multivariate methodology with machine learning to identify ruptures in flexible CO₂ injection pipelines, using surface measurements that minimize the occurrence of incorrect diagnoses.

### STATE OF THE ART

In the state of the art, there are methods that indicate techniques for detecting pipeline failures that aim to reduce distortions and false alarms. However, these methods do not identify the exact type of failure in the pipelines, that is, they do not provide precise diagnoses to facilitate the adjustment operations.

The paper “Wang, Tong, et al. “Research of sensor fault detection based on the residual filtered for the oilfield petroleum exploited system.” 2013 25th Chinese Control and Decision Conference (CCDC). IEEE, 2013” presents a method for detecting failures in sensors used in oil exploration systems. More specifically, the work proposes a method based on residual filtering by using the PCA (principal component analysis) technique with an EWMA (exponentially weighted moving average) filter to identify and diagnose the failures, reducing the distortions and false alarms. However, this method only signals that the process has deviated from normality, without specifying the reason. In addition, the trained PCA uses only normal operation data, which limits its ability to identify anomalies, and the applied noise filtering can introduce significant delays in detecting abrupt failures.

The paper “Wang, Qinying, et al. “Evolution of corrosion prediction models for oil and gas pipelines: From empirical-driven to data-driven.” Engineering Failure Analysis 146 (2023): 107097” discloses machine learning (ML)-based models for predicting corrosion in oil pipelines. However, the proposed method is addressed to predicting and monitoring corrosion processes in pipelines, providing information for estimating the corrosion rate, crack depth, and the effectiveness of corrosion inhibitors, without any indication of specific gas line rupture events.

The paper “Raschka, Sebastian. “Predictive modeling, supervised machine learning, and pattern classification.” Dr. Sebastian Raschka 25 (2014)” discloses a predictive modeling defined by pattern classification using machine learning. However, the paper focuses on detailing the typical workflow of supervised machine learning, presenting analyses of popular algorithms. In this way, there is no indication of the use of a method for detecting specific and rare failures in pipelines. In addition, the document indicates a static process, without continuous adjustment based on operational results, and does not suggest a solution to the lack of data that limits the monitoring capacity of existing detection systems.

Therefore, as can be seen in the description of the above-mentioned documents of the state of the art, the existing methods do not disclose or suggest the detection of specific failures in critical events, since they do not present an optimized search space for obtaining a precise and adaptable trained model.

In this way, the present invention presents a method that uses a hybrid database, that is, one that brings together information on operational data and phenomenological models, in addition to feedback from performance metrics by combining variable data in the optimizer, generating machine learning models with greater specialization capacity and consequently enabling an increased capacity for classifying critical events.

### SUMMARY OF THE DISCLOSURE

The present invention pertains to the technical field of offshore oil exploration and production and the technology for monitoring the integrity of gas injection wells in oil reservoirs. More specifically, it relates to a method for identifying pipeline failures, which comprises the following steps: creating at least one hybrid database comprising operational data and simulated event data; identifying, through a set of global optimization instructions, at least one model that best represents the actual behavior of the pipeline to be inspected; generating at least one key performance indicator (KPI), based on the implementation of at the least one selected model; monitoring the at least one KPI, in which if the at least one KPI exceeds at least one predefined limit value, at least one alarm is triggered, indicating the possible presence of at least one failure in the inspected pipeline.

Furthermore, according to a preferred embodiment of the present invention, the set of global optimization instructions comprises the following steps: (i) generating, from the at least one hybrid database, a series of model families based on a statistical technique of dimensionality reduction of a data set; (ii) selecting the number of components for the statistical technique of dimensionality reduction used; (iii) defining the confidence limit of the precision evaluation technique; (iv) testing, by counting the number of false positives, the models generated by the statistical technique of dimensionality reduction using the confidence limits defined by the precision evaluation technique, on operational data; (v) testing, by counting the number of false negatives, the models generated by the statistical technique of dimensionality reduction using the confidence limits defined by the precision evaluation technique, on simulated event data; (vi) returning to step (ii) to choose a new number of principal components and to step (iii) to establish a new confidence limit, and rerunning the performance tests defined in steps (iv) and (v); (vii) evaluating the performance of the models generated from the objective function; (viii) establishing the generated model that presents the best performance.

Complementarily, according to a preferred embodiment of the present invention, the used operational data are data obtained during the normal operation of the injector wells and from anomalous behaviors generated by process simulators.

Additionally, according to a preferred embodiment of the present invention, the simulated event data are data estimated from phenomenological engineering models, based on theoretical foundations of thermodynamics and flow.

In addition, according to a preferred embodiment of the present invention, the statistical technique of dimensionality reduction of a data set used is PCA (Principal Component Analysis), with two principal parameters: the number of principal components and the confidence limit.

More specifically, according to a preferred embodiment of the present invention, the precision evaluation technique used is SPE (Sum of Prediction Errors).

Complementarily, according to a preferred embodiment of the present invention, the confidence limit obtained by the SPE acts as a decision criterion in detecting pipeline failures; in which the confidence limit obtained by the SPE is compared with the predefined confidence limit in the PCA model, and determines whether a new data point behaves anomalously in relation to the normal behavior modeled by the PCA; in which the SPE confidence limit is established based on the statistical distribution of the SPE during normal operating periods.

Additionally, according to a preferred embodiment of the present invention, the model generated by the statistical technique for dimensionality reduction of a data set that presents the best performance is the PCA model that presents the smallest number of incorrect diagnoses, minimizing both false positives and false negatives.

### BRIEF DESCRIPTION OF THE FIGURES

The patent or application file contains at least one drawing executed in color. Copies of this patent or patent application publication with color drawing(s) will be provided by the Office upon request and payment of the necessary fee.

In order to complement the present description and obtain a better understanding of the features of the present invention, and according to a preferred embodiment thereof, a set of figures is presented, which, in an exemplary, though not limitative, manner, represent its preferred embodiment.

FIG. 1 represents the simplified flowchart of the last stage of a gas reinjection plant in an oil reservoir, according to a preferred embodiment of the present invention.

FIG. 2 represents an example of the “signature” of a line break visualized through variables measured in the gas reinjection plant, according to a preferred embodiment of the present invention.

FIG. 3 presents a flowchart of a gas reinjection plant model with 3 injection wells generated in a commercial simulator, according to a preferred embodiment of the present invention.

FIG. 4 presents a graph that defines an example of a search space for the best combination of the number of PCA components and the SPE confidence limit in relation to the number of false diagnoses (the graph data is normalized), according to a preferred embodiment of the present invention.

FIG. 5 illustrates a graph that defines an example of a KPI in historical reinjection well data, showing the regions of normality and abnormality based on SPE (not normalized), according to a preferred embodiment of the present invention.

FIG. 6 presents a graph that defines an example of a KPI in simulated data of reinjection well line break, based on SPE (not normalized), according to a preferred embodiment of the present invention.

FIG. 7 presents a graph showing the result of an application of the pipeline failure identification method, based on normalized SPE, according to a preferred embodiment of the present invention.

FIG. 8 presents a graph showing the result of an application of the pipeline failure identification method with historian visualization, according to a preferred embodiment of the present invention.

FIG. 9 presents a graph demonstrating the contribution of the model's input variables to the deviation calculated by the SPE in an application of the pipeline failure identification method, according to a preferred embodiment of the present invention.

FIG. 10 illustrates a real case of a break in a gas injection line on an offshore oil platform. The IRDR method not only detects the failure event but also demonstrates a significant anticipation potential, allowing for the identification of signs of the rupture before it occurs.

### DETAILED DESCRIPTION OF THE DISCLOSURE

The present invention pertains to the technical field of offshore oil exploration and production and the technology for monitoring the integrity of gas injection wells in oil reservoirs. More specifically, it relates to a method for identifying pipeline failures, which comprises the following steps:
creating at least one hybrid database comprising operational data and simulated event data;
identifying, through a global optimization algorithm, at least one model that best represents the actual behavior of the pipeline to be inspected;
generating at least one key performance indicator (KPI) based on the implementation of the at least one selected model;
monitoring the at least one KPI, in which if the at least one KPI exceeds at least one predefined limit value, at least one alarm is triggered, indicating the possible presence of at least one failure in the inspected pipeline.

In this way, the global optimization algorithm comprises the following steps:
(i) generating, from the at least one hybrid database, a series of model families based on a statistical technique of dimensionality reduction of a data set;
(ii) selecting the number of components for the statistical technique of dimensionality reduction used;
(iii) defining the confidence limit of the precision evaluation technique;
(iv) testing, by counting the number of false positives, the models generated by the statistical technique of dimensionality reduction using the confidence limits defined by the precision evaluation technique, on operational data;
(v) testing, by counting the number of false negatives, the models generated by the statistical technique of dimensionality reduction using the confidence limits defined by the precision evaluation technique, on simulated event data;
(vi) returning to step (ii) to choose a new number of principal components and to step (iii) to establish a new confidence limit, and rerunning the performance tests defined in steps (iv) and (v);
(vii) evaluating the performance of the models generated from the objective function;
(viii) establishing the generated model that presents the best performance.

In particular, the used operational data are preferably data obtained during the normal operation of the injection wells and from anomalous behaviors generated by process simulators. To use operational data, it is necessary to select normal operating periods of the reinjection plant. Periods of at least 1 to 2 years of normal operation should be searched in the plant's operational history. Sampling can be done at intervals of 1 to 30 seconds, avoiding exceeding this maximum value, unless there is some particularity in the plant or in the data acquisition and recording system. It is important to pay attention to the degree of data compression in the historical data; ideally, the variables should have a low degree of compression to preserve the real dynamics of the operation, preventing them from being filtered or excessively smoothed.

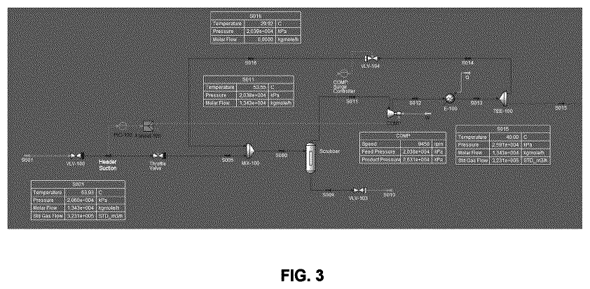

Additionally, considering that the line ruptures are rare events and do not occur regularly in production systems, it is necessary to create a database of simulated ruptures. The rarity of these incidents makes it difficult to effectively train monitoring models, as there is a scarcity of real data representing such extreme conditions. Simulated event data are preferably estimated from phenomenological engineering models, based on theoretical foundations of thermodynamics and flow to ensure adequate representation of the generated events. Thus, it is crucial to perform the phenomenological modeling of the compression plant or use commercial simulators that employ this approach. FIG. 3 presents an example of a model of a compression plant and reinjection lines that is generated in a commercial simulator. It is recommended that the simulated event database be comprehensive enough to encompass representative operating modes of the reinjection system. Therefore, multiple rupture scenarios must be generated, considering different reinjection well alignments, processed flow rates, gas compositions, etc.

This hybrid database is essential to ensure the system has a solid foundation for identifying normal patterns and detecting anomalies. By incorporating failure simulations generated by phenomenological models, it is possible to enrich the database with critical scenarios that would be unlikely to occur during the normal operation, allowing monitoring models to be trained more robustly and better prepared to recognize and respond to the line rupture events.

The concatenation of real operational data with data generated by phenomenological simulators is a technique known as PIML (Physics-Informed Machine Learning). This approach combines the precision of physics-based models with the learning capacity of machine learning algorithms, creating a powerful tool for generating rare operational patterns. PIML is particularly useful in scenarios in which critical events, such as catastrophic failures, are rare and difficult to capture with historical data alone. By integrating these two sources of information, PIML allows models to learn not only from normal operating behavior but also from simulations that anticipate failure scenarios, making the monitoring system more comprehensive and prepared to handle adverse situations.

With the hybrid database ready, it is possible to move on to the second part of the pipeline failure identification method. This second part involves defining the model generated by the statistical technique of dimensionality reduction by using the confidence limits defined by the precision evaluation technique through the global optimization algorithm.

In addition, the statistical technique used to reduce the dimensionality of a dataset is preferably PCA, which preserves the original variability as much as possible. The PCA technique transforms a set of potentially correlated variables into a new set of linearly uncorrelated variables, called principal components, which capture the most relevant characteristics of the data. This transformation facilitates the identification of hidden patterns and simplifies the complexity of the original data. To maximize the PCA model performance, it is important to define two aspects:
(1) Number of principal components: refers to the number of principal components that are retained in the model after applying PCA. PCA transforms a set of possibly correlated original variables into a new set of uncorrelated variables, known as principal components. Each principal component is a linear combination of the original variables and is ordered such that the first principal component captures most of the variability present in the data, the second component captures most of the residual variability, and so on. The goal of PCA is to reduce the dimensionality of the dataset while retaining as much information as possible. To achieve this, a subset of the principal components is selected, usually the first ones, that capture most of the variability. The chosen “number of components” affects the amount of variability from the original data that is preserved. In general, a smaller number of components makes the model simpler but may lose some information, while a larger number of components preserves more information but may lead to a more complex model. The ideal number of components is determined based on the amount of accumulated variability that one wishes to maintain, for example, by analyzing the variance explained by each component. If the first three components explain 95% of the total variance, one might choose to use only those three. This can be decided by the global optimizer described herein.
(2) Confidence limit: This refers to the statistical limits that help identify whether a new observation fits the normal behavior described by the principal components. After constructing the PCA model, the confidence limits are defined to determine what is considered “normal” and “abnormal” data behavior. When a new observation is projected into the principal component space, it is compared to these limits. If the projection of the new observation falls within the limits, it is considered normal; otherwise, it can be classified as an outlier or an anomaly. The confidence limits can be defined based on statistical techniques such as confidence intervals and confidence ellipses in the principal component space. They indicate the interval within which most normal data are expected to fall. For example, a 98% confidence limit means that, statistically, 98% of the observations should fall within this interval. In monitoring systems, such as for detecting injection line breaks, the confidence limits are used to generate alarms. If an observation exceeds the confidence limit, it may indicate an anomalous condition, such as a possible break, triggering an alarm for the monitoring team.

Furthermore, the precision evaluation technique used is preferably the SPE (Sum of Prediction Errors), which is a metric used to evaluate the precision of a statistical model, especially in contexts such as time series or regression models. The SPE allows the identification of the model that best represents the actual behavior of the injection line, minimizing the prediction errors.

In this sense, in fault detection, the SPE is compared with a predefined confidence limit to determine whether a new data point behaves anomalously in relation to the normal behavior modeled by PCA. The SPE, in this case, is a metric used in PCA (Principal Component Analysis)-based anomaly detection methods to evaluate the discrepancy between the observed data and the constructed model. In the context of failure detection, the SPE helps identify when a new data set deviates from the behavior considered “normal” as described by the principal components of the PCA model. The confidence limit for the SPE is established based on the statistical distribution of the SPE during normal operating periods. This limit defines a boundary that separates normal from anomalous behavior. If the SPE of a new observation exceeds this limit, the observation is considered an anomaly. In practice, if the SPE of a new sample is within the confidence limit, it is considered consistent with the normal behavior of the system. Otherwise, if the SPE exceeds the limit, it indicates an abnormal behavior or a possible failure. Therefore, the SPE confidence limit acts as a decision criterion in the detection of gas reinjection line ruptures, helping to identify significant deviations from the expected operational pattern. In short, the SPE is a measure of how much a new observation deviates from the expected normal behavior, as described by the principal components of the PCA. The confidence limit defines a cutoff value for this measurement, helping to differentiate between normal variations and anomalies in the monitored system.

In short, the “number of components” affects the complexity and the variability capture capacity of the PCA model, while the SPE “confidence limit” defines the criteria for distinguishing between normal and anomalous behavior in the monitored system. These two parameters of the pipeline failure identification method are defined by the global optimization algorithm.

Thus, the global optimization algorithm comprises selecting the PCA model that presents the smallest number of incorrect diagnoses, minimizing both false positives and false negatives. Global optimization algorithms are techniques used to find the best solution to a problem, especially when the function to be optimized has multiple local minima or maxima. These algorithms are designed to avoid getting stuck in local optima, seeking a globally optimal solution. The examples include evolutionary algorithms, such as Genetic Algorithms (GA) and Differential Evolution (DE), and swarm algorithms, such as Particle Swarm Optimization (PSO) and Ant Colony Optimization (ACO). The choice of the global algorithm for the pipeline failure identification method is free, but it must be an algorithm with global search characteristics to minimize the chances of the model being found being a suboptimal solution.

The objective function, represented in Equation 01 below, evaluates the performance of the models:

$$J = a \sum \frac{FP}{{N}_{PI}} + b \sum \frac{FN}{{N}_{Sim}} \qquad ( Equation 01 )$$

In this equation, J is the value of the objective function, FP represents the number of false positives, FN the number of false negatives, N_{P1} the sample size of normal data, and N_{Sim} the sample size of simulated data. The parameters a and b are weights that allow the user to adjust the monitoring system to have fewer false positives or negatives, respectively. A balanced distribution of these weights occurs when a=b or when these parameters have close values, because if a>>b, the chances of not detecting disruptions are high, while b<<a results in a system with many false positive alarms.

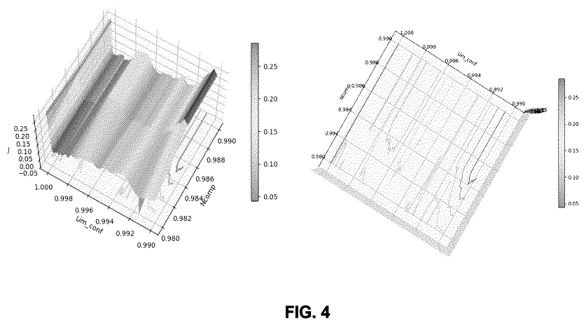

The objective function stores the false diagnosis count values for each combination of the number of PCA components and the SPE confidence limit. Thus, it is possible to generate a perspective of the search space, as illustrated in FIG. 4.

From there, it is possible to choose a model or family of models with the best performance in identifying normal operation or gas reinjection line rupture situations. Eventually, it is possible to find models with similar performance in the solutions, allowing the selection of another model if some type of redundancy in monitoring is desired.

Once the model is defined, it must be implemented in real time to monitor the KPI. It is recommended to normalize the SPE so that the limit value between normal operation and anomaly is equal to 1.0 (one).

The KPI is continuously monitored by the operations team, in such a way that if the KPI exceeds a predefined limit value, alarms are triggered, indicating that the injection line has suffered an abrupt and catastrophic failure, allowing a rapid response to mitigate the associated risks.

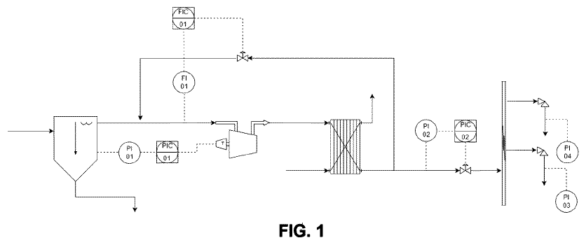

FIG. 1 illustrates, in a simplified form, the final compression stage of a gas reinjection plant. This flowchart identifies some basic elements of the process and their interconnections: (1) initially, the already pressurized gas passes through a scrubber, which removes any condensate formed or carried over from previous stages; (2) the gas is then directed to a compressor, which raises its pressure to levels suitable for reinjection; (3) after the compression, the gas exits heated due to the thermodynamic effect and passes through a cooler; (4) part of the gas is redirected to the compressor suction through a line controlled by an anti-surge valve, preventing the machine from entering surge and causing excessive vibrations; (5) finally, the main gas line terminates in a header that feeds the injection wells.

In cases of rupture in the reinjection well lines, this occurs downstream of the compression plant shown in FIG. 1, that is, in the region between the plant and the wellhead on the seabed. However, in this section, the installation of pressure, flow, or temperature meters is not common, making detection of these ruptures a challenge. An alternative is to monitor the behavior of the variables measured in the compression plant, located upstream of the reinjection lines.

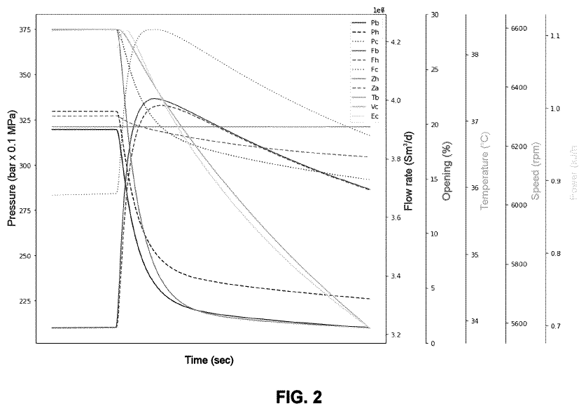

In this context, FIG. 2 presents the behavior of the compression plant during a simulated line rupture event, based on the following parameters: Pb—Riser pressure; Tb—Riser temperature; Fb—Riser flow rate; Ph—Header pressure; Pc—Compressor discharge pressure; Fc—Compressor discharge flow rate; Zh—PIC header valve; Fa—Compressor flow rate (anti-surge); Za—FIC valve (anti-surge); Ec—Compressor power; Vc—Compressor speed; Pi—Compressor inlet pressure.

Therefore, according to the steps of the pipeline failure identification method described above, this method enables the detection of specific failures in critical events, since it presents an optimized search space for obtaining a precise and adaptable trained model, by using a hybrid database and feedback from performance metrics combining variable data in an optimizer, generating machine learning models with greater specialization capacity and consequently enabling an increased ability to classify critical events.

### EXEMPLARY APPLICATION OF THE DISCLOSURE

Demonstrations were performed to exemplify one of the numerous applications of the invention, without limiting its scope.

A CO₂-rich natural gas injection well was chosen, whose available variables in the last compression stage were: Injection flow rate; Compressor discharge pressure; Compressor discharge flow rate; Compressor anti-surge recycle flow rate; Anti-surge valve opening; Compressor power; and Compressor speed.

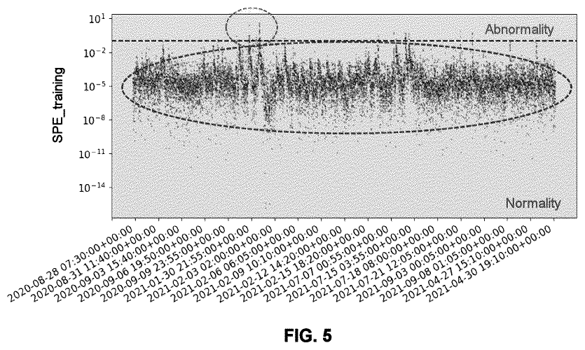

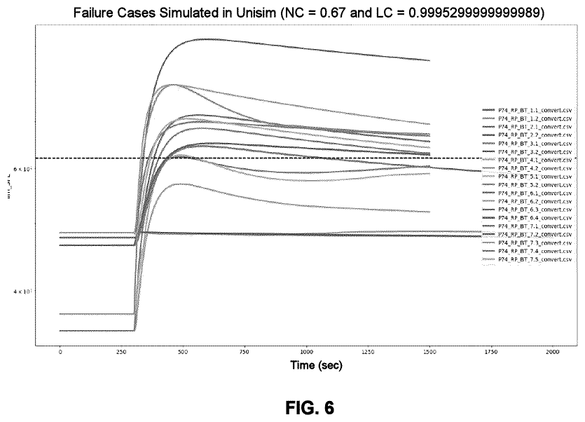

Using the pipeline failure identification method, according to a preferred embodiment of the present invention, a set of models was generated through optimization. The KPI performance for a normal operation data set is shown in FIG. 5, while FIG. 6 shows the behavior of the monitoring system in cases of simulated line ruptures. As can be noted, the method allows for highly efficient classification of line integrity, although it cannot guarantee 100% precision in diagnoses.

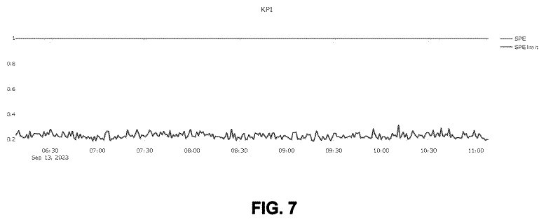

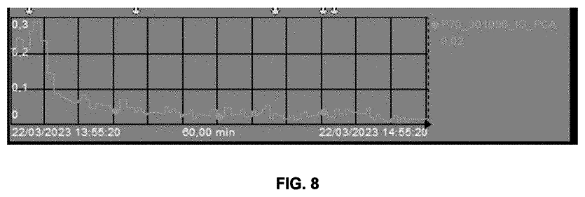

FIGS. 7 and 8 show the pipeline failure identification method, according to a preferred embodiment of the present invention, in real time monitoring a gas reinjection well.

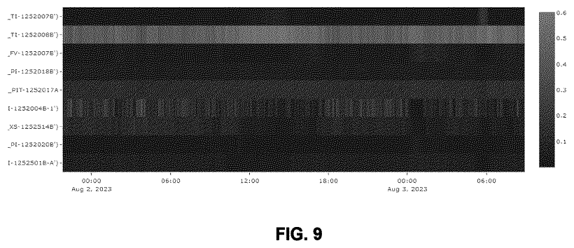

FIG. 9 highlights an additional advantage of the pipeline failure identification method, according to a preferred embodiment of the present invention: the ability to identify the degree of contribution of each input variable to the SPE deviation. By calculating the SPE, it is possible to estimate the level of deviation of each model input variable and, therefore, create a snapshot of which variables exhibit the greatest deviations from expected behavior. This functionality allows monitoring teams to quickly and precisely identify the root cause of potential anomalies, making operational diagnostics more efficient.

In a more comprehensive example, Table 1 presents a performance comparison between the IRDR method and a conventional methodology for detecting ruptures in gas injection lines. The conventional method, as previously described, is based exclusively on normal operation data and uses multiple single-variable models to construct its operational diagnostics. In contrast, IRDR stands out for its multivariate approach, which considers the specifics of the rupture event, resulting in more precise diagnoses and greater traceability in failure classification. The conventional approach, by disregarding the multivariate nature of the problem, tends to generate a high number of incorrect diagnoses, hindering the precision and clarity of the results.

The presented results were collected over three years of operation at five offshore oil and gas production units, during which no actual ruptures occurred in the injection lines. This real data set allowed for the analysis of false positives over time, while the precision of false negatives was performed using a simulated data set, including more than 250 different operational scenarios.

The results show that the IRDR methodology provides a significant reduction in false diagnoses: on average, there was a 60% decrease in false negatives and a 90% decrease in false positives, demonstrating IRDR's superior diagnostic precision compared to conventional methods.

A final illustrative example is the case of a real rupture in a gas injection line that occurred at an offshore oil and gas production unit in Brazil. According to the forensic teams, the event was abrupt, but evidence indicates that the line's integrity began to deteriorate hours before the rupture. At the time of the incident, the IRDR method was still under development and therefore not active in monitoring the injection well. However, this event provides an excellent opportunity to evaluate IRDR performance using historical data.

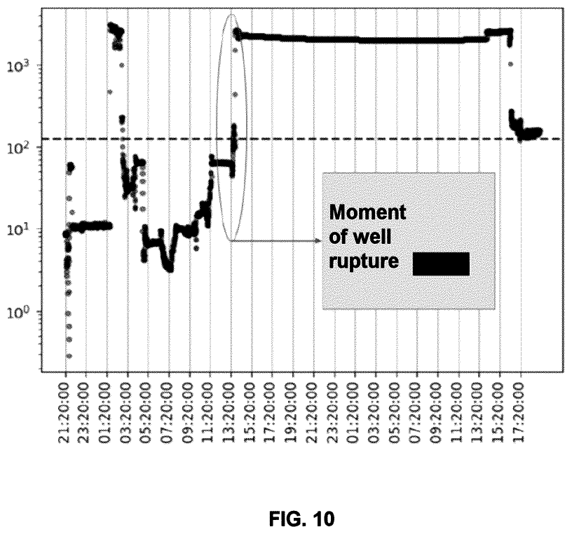

In FIG. 10, the IRDR's SPE is plotted against time, encompassing moments before and after the rupture. The figure discloses that the IRDR's KPI crosses the critical limit established during model training precisely at the moment of catastrophic failure, demonstrating the method's effectiveness in practice.

In addition, it is observed that approximately 12 hours before the event, the IRDR had already signaled an anomaly related to the rupture, indicating its potential ability to predict failures in advance. This result suggests that the IRDR can become a valuable tool for anticipating accidents, providing time for preventive actions.

Those skilled in the art will value the knowledge presented herein and will be able to reproduce the invention in the presented embodiments and in other variations encompassed by the scope of the attached claims.

TABLE 1
Evaluation of the IRDR's performance compared to
a conventional monitoring method over a 3-year period
on 5 different oil and gas production platforms.

| | | False Total | Reduction | Reduction |
|---|---|---|---|---|
| | | of False | in False | in False |
| | | Diagnoses | Negatives | Positives |
| | | (Positives and | through | through |
| Scenario | Method | Negatives) | IRDR (%) | IRDR (%) |
| Platform X | IRDR | 20 | 55.6 | 92.5 |
| | Conventional | 178 | | |
| | Method | | | |
| Platform Y | IRDR | 21 | 64.3 | 89.9 |
| | Conventional | 173 | | |
| | Method | | | |
| Platform Z | IRDR | 5 | 100 | 96.3 |
| | Conventional | 138 | | |
| | Method | | | |
| Platform W | IRDR | 16 | 0 | 98.1 |
| | Conventional | 631 | | |
| | Method | | | |
| Platform V | IRDR | 13 | 88.8 | 74.1 |
| | Conventional | 71 | | |
| | Method | | | |

1. A method for identifying pipeline failures comprising:
creating at least one hybrid database comprising operational data and simulated event data;
identifying, through a set of global optimization instructions, at least one model that best represents the actual behavior of the pipeline to be inspected;
generating at least one key performance indicator (KPI) based on an implementation of the at least one model; and
monitoring the at least one KPI, in which if the at least one KPI exceeds at least one predefined limit value, at least one alarm is triggered, indicating possible presence of at least one failure in the inspected pipeline.

2. The method of claim 1, wherein the set of global optimization instructions comprises:
(i) generating, from the at least one hybrid database, a series of model families based on a statistical technique of dimensionality reduction of a data set;
(ii) selecting a number of components for the statistical technique of dimensionality reduction used;
(iii) defining a confidence limit of a precision evaluation technique;
(iv) testing, by counting a number of false positives, models generated by the statistical technique of dimensionality reduction using the confidence limits defined by the precision evaluation technique, on operational data;
(v) testing, by counting a number of false negatives, models generated by the statistical technique of dimensionality reduction using the confidence limits defined by the precision evaluation technique, on simulated event data;
(vi) returning to step (ii) to choose a new number of principal components and to step (iii) to establish a new confidence limit, and rerunning performance tests defined in steps (iv) and (v);
(vii) evaluating performance of models generated from an objective function;
(viii) establishing a generated model that presents the best performance.

3. The method of claim 1, wherein the operational data are data obtained during normal operation of injection wells and from anomalous behaviors generated by process simulators.

4. The method of claim 1, wherein the simulated event data are data estimated from phenomenological engineering models, based on theoretical foundations of thermodynamics and flow.

5. The method of claim 2, wherein the statistical technique of dimensionality reduction of a data set used is PCA (Principal Component Analysis), with two principal parameters: the number of principal components and the confidence limit.

6. The method of claim 2, wherein the precision evaluation technique used is SPE (Sum of Prediction Errors).

7. The method of claim 5, wherein the confidence limit obtained by the SPE acts as a decision criterion in detecting pipeline failures;
in which the confidence limit obtained by the SPE is compared with the predefined confidence limit in the PCA model, and determines whether a new data point behaves anomalously in relation to the normal behavior modeled by the PCA;
in which the SPE confidence limit is established based on the statistical distribution of the SPE during normal operating periods.

8. The method of claim 2, wherein the model generated by the statistical technique of dimensionality reduction of a data set that presents the best performance is a PCA model that presents the smallest number of incorrect diagnoses, minimizing both false positives and false negatives.

9. The method of claim 2, wherein the objective function that evaluates the performance of the models is defined by:
$$J = a \sum \frac{FP}{{N}_{PI}} + b \sum \frac{FN}{{N}_{Sim}} .$$
